(19) United States
(12) Patent Application Publication
(10) Pub. No.: US 2010/0020177 A1
(43) Pub. Date: Jan. 28, 2010

(54) Apparatus for remotely, privately, and reliably monitoring a fixed or moving location, property or asset

(76) Inventor: Robert James Carstens, (US)

Correspondence Address: Robert J. Carstens, 1985 W. Bristlecone Ct., Santa Rosa, CA, 95403, US

(21) Appl. No.: 12/178,349

(22) Filed: Jul. 23, 2008

(51) Int. Cl. H04N 7/18

(52) U.S. Cl. 348/158; 348/E07.085

(57) ABSTRACT

An apparatus for visually and environmentally monitoring a location, property or asset remotely is disclosed comprising elements of a radio transceiver, an antenna, a visual input device, a digital signal processing computing device, a data storage mechanism, a mobile power source, and environmental sensors. The machine's elements are configured in such a manor that the apparatus has unique characteristics of being able to be installed at a location that is mobile; provides a visual link to a specified personal computer (PC) or wireless mobile device at another location that is solely and privately observable by the authorized user of the specified PC or wireless mobile device; is highly secure to prevent unauthorized access to the monitored visual and environmental data; is highly reliable compared to other monitoring systems.

### BACKGROUND OF THE INVENTION

This invention relates generally to the field of site surveillance and more specifically to an apparatus for visual and environmental monitoring a location remotely. Visual Monitoring systems often called surveillance systems have been available for many years. They comprise of two basic parts, a video camera, and a television set (TV monitor). The video camera is placed at an observation point and the TV monitor is placed at a remote location to view the captured video from the camera. The earliest systems were closed circuit black and white video cameras connected by wires to TV monitors. Additionally, these early systems had no ability to record the video. Because these early systems could not record what the cameras captured, people would need to sit in front of the TV monitors to observe what the cameras were viewing. These systems were typically found in office buildings and factories that would deploy many cameras to observe critical locations throughout the facility, typically after hours when few if any people were in the facilities. The cameras would be wired to their corresponding TV monitors at a central location where an individual could view all the camera's video at the same time. The camera typically needed to be in the same physical building as the TV monitors because of the routing of the wires between the cameras and TV monitors.

As video tape recorders started becoming cost effective, storage of the cameras visual view became possible. Rather then just feed the cameras closed circuit signal to a TV monitor, the signal could be connected to a video tape recorder and the tape could now record the camera's images. This storage capability now added the feature of not requiring people to monitor the TV monitors real-time. The stored video could then be reviewed after an incident occurred at the monitored facility or site to determine more exact details. With the advancement of digital recording methods, computer memory devices have on the most part replaced the video tape recorders, mostly by Computer

Hard Disk Drives. This technology advancement improved the recorded video quality, and reliability. Hard Disk Drives also provided a means to access any segment of the recorded video quicker without fast forwarding or rewinding like you would a video tape.

More recently a wireless radio frequency protocol was developed to wirelessly connect computers and computer peripherals at a home or small business know as a Wireless Local Area Networks (LAN) named WiFi. The monitoring industry took advantage of this technology to improve the installation process of connecting the cameras to the TV monitors or recording devices wirelessly. This results in not having to run wires between the camera and TV monitors or recording devices. This also facilitated being able to have the camera located in another building from the TV monitors or recording devices. The distances between the camera and the TV monitors or recording devices is limited because the WiFi systems are low power and were intended to have range within a home or small office. Range extenders can be deployed which double the range, but it is still limited to hundreds of feet.

Remote Monitoring from a location farther away from the cameras and beyond the same premises or an adjacent facility being monitored became recently available. High speed connection by way of phone lines or cable TV modems provided abilities to transmit the high bandwidth signals requirements for video long distances. These connection techniques are known as Wide Area Networks or WAN. These monitoring systems typically connect the camera to a computing device at the monitored location by way of a wired or wireless connection, then in turn connect to telephone or cable modems that connect to the Internet. Once the video is on the Internet, the video can be viewed by any authorized computer anywhere in the world connected to the Internet. These systems typically have a third party that provides the system and service to the people that want the remote monitoring feature. These service providers have a centralized recording device, typically a computer server with a large Hard Disk Drive array that stores their customer's video for a fee. The customer can, from their Internet connected Personal Computer, view the video from the centralized recording device. Some systems also offer the ability for the customer to remotely monitor the video on a Wireless Mobile Device such as a Cellular Telephone.

There are four deficiencies of the prior technology that this invention improves. The first improvement is the current consumer systems are designed to be in fixed locations. They cannot monitor sites that are moving such as automobiles or boats. The second deficiency is privacy and security of the monitored video. The current systems typically have third party computer systems to store the video for remote viewing. People other than the system's owner can view the stored video. Additionally, current consumer Remote Monitoring Systems are connected to the Internet, which can allow for a person to obtain unauthorized access, commonly known as hacking into the site being monitored. The third deficiency is reliability. The current systems generally are dependent on local AC power and a hard-wired connection to the Internet. If AC power or the hard wires are cut to the monitored site, the system fails to be accessible for remote monitoring.

### BRIEF SUMMARY OF THE INVENTION

The primary advantage of the invention is to provide an apparatus to visually and environmentally monitor a site of the owner's choosing that can be mobile.

Another advantage of the invention is to provide an apparatus to visually and environmentally monitor a site in a private and secure manor that only the owner of the apparatus will have access to view all data.

Another advantage of the invention is to provide an apparatus to visually and environmentally monitor a site in a way that is highly available and reliable in adverse conditions.

Other objects and advantages of the present invention will become apparent from the following descriptions, taken in connection with the accompanying drawings, wherein, by way of illustration and example, an embodiment of the present invention is disclosed. In accordance with a preferred embodiment of the invention, an apparatus for visual and environmental monitoring that is able to be installed at a location that is mobile comprising: a radio transceiver, an antenna, a visual input device, a mobile power source.

In accordance with a preferred embodiment of the invention, there is disclosed an apparatus for visual and environmental monitoring a location remotely with privacy and secure from outside intrusion of the recorded video and data comprising: a radio transceiver, an antenna, a visual input device, a digital signal processing/computing device, a data storage mechanism.

In accordance with a preferred embodiment of the invention, there is disclosed an apparatus for visual and environmental monitoring a location remotely with high reliability comprising: a radio transceiver, an antenna, a visual input device, a digital signal processing/computing device, a data storage mechanism, a mobile power source.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram of the invention.

FIG. 2 is a block diagram of typical visual remote monitoring system.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

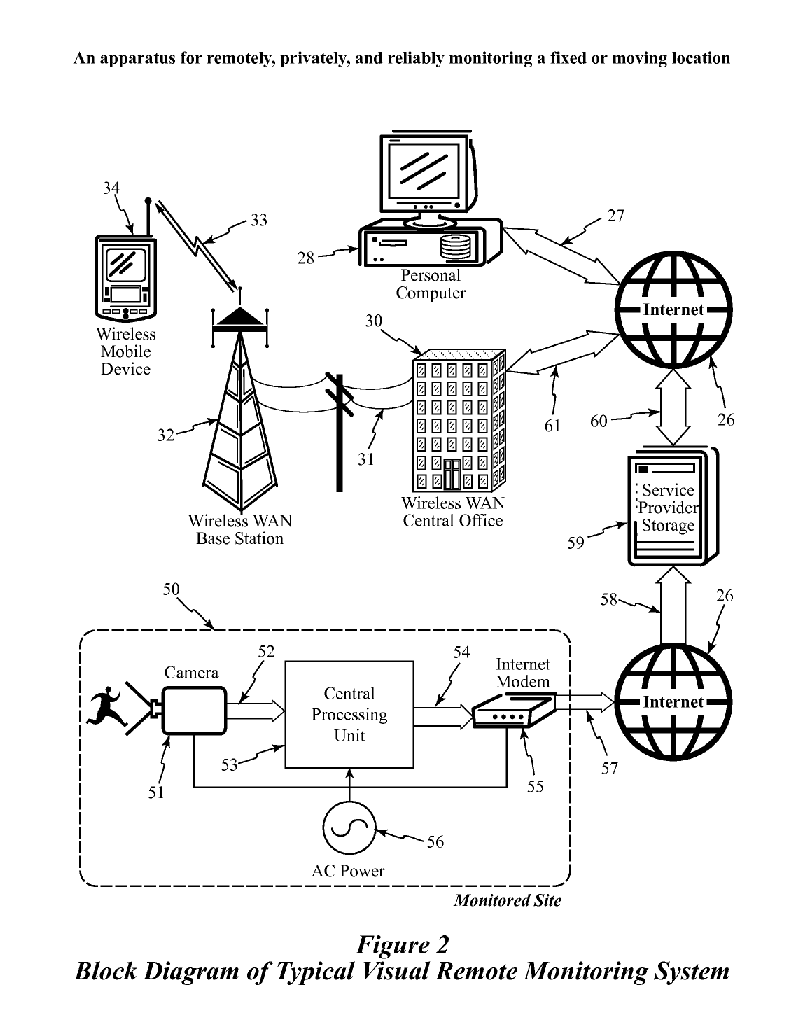

Turning first to FIG. 2, a typical Visual Remote Monitoring System is shown. The Monitored Site 50 has the elements of a Camera 51, Central Processing Unit 53, and an Internet Modem 55. The Camera 51 captures the desired video and sends it to the Central Processing Unit 53 through the communications path 52. The Central Processing Unit puts the video into a format proper for transmission through the Internet Modem 55 by way of a connection 54. The Internet Modem 55 converts the video signal to the proper protocol to transmit the video to the Internet 26. The video is sent to the Internet for remote viewing, which will be discussed later. The type of connection 57 to the Internet 26 is determined by the Internet Service Provider, ISP. Typically this connection 57 is a hard wired telephone line such as Digital Subscriber Line (DSL) protocol or a Cable TV connection where the digital video signal is sent over the cable television infrastructure. In all cases the connection needs to be a high-speed connection, known as broadband, because a reasonably good quality picture requires a large video data file. This hard wired connection 57 to the Internet 26 forces the Monitored Site 50 to be stationary.

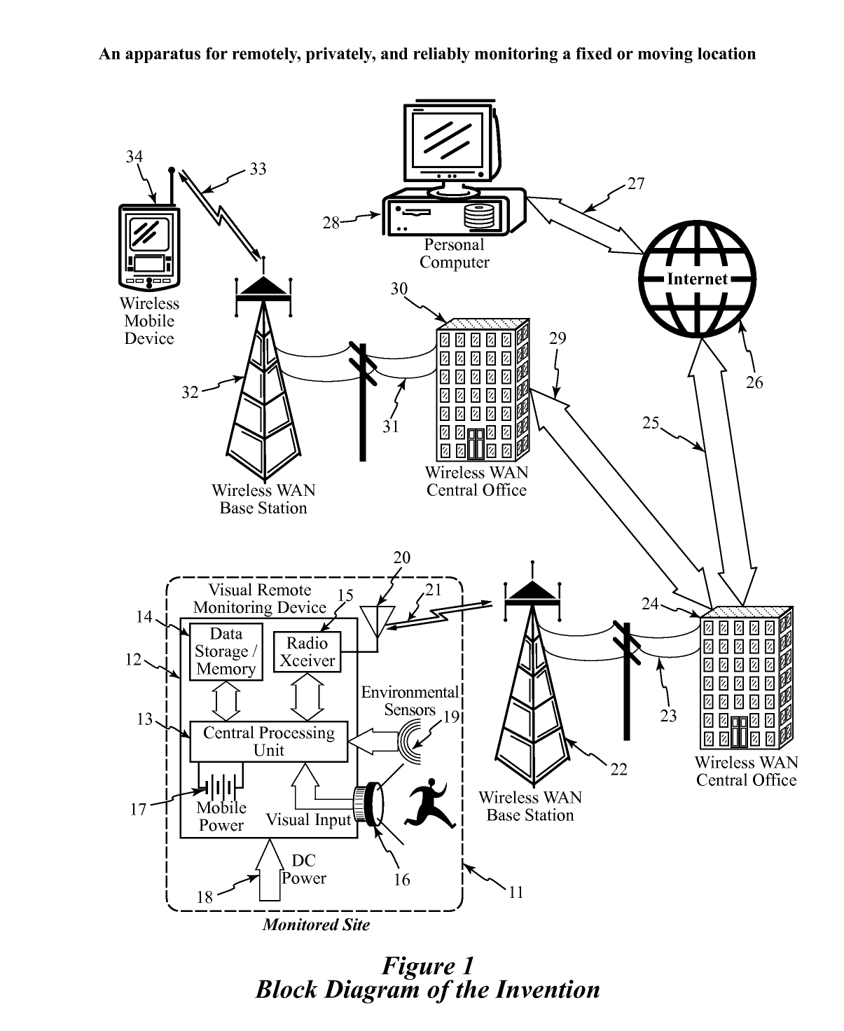

Now, turning to FIG. 1, the invention of a Visual Remote Monitoring System is shown, which is a patentably improvement over that system shown in FIG. 2. In FIG. 1, the Monitored Site 11 has an apparatus, a Visual Remote Monitoring Device 12 installed to visually monitor a particular location. The Visual Remote Monitoring Device 12 comprising of a Visual Input Device 16, a Data Storage/Memory mechanism 14, a Radio Transceiver 15, and a Mobile Power Source 17, all connected to a Central Processing Unit 13. The wherein said Visual Input Device 16 can be, but is not limited to a digital image sensor or a digital video camera. The wherein said Data Storage/Memory mechanism 14 can be, but is not limited to a solid-state integrated circuit consisting of digital memory cells or a device that magnetically stores data. The wherein said Mobile Power Source 17 can be, but is not limited to a battery or a rechargeable battery. The wherein said Central Processing Unit 13 can be, but is not limited to a microcomputer or a microprocessor and digital signal processor. Similar to the typical Visual Remote Monitoring System in FIG. 2, the Central Processing Unit 13 of FIG. 1 processes the video from the Visual Input Device 16. It stores the video in the Data Storage/Memory mechanism 14. Additionally, the Central Processing Unit 13 can send the video to the Radio Transceiver 15 to transmit the captured video away from the Monitored Site 11 by way of an Antenna 20 for remote viewing. The transmitted video can be either current (real time) video or past events that are stored in the Data Storage/Memory mechanism 14. An internal Mobile Power 17 source or a DC Power 18 source derived from the Monitored Site 11 or both, power the Visual Remote Monitoring Device 12. The invention's use of transmitting video wirelessly using Radio Transceiver 15 and the Antenna 20 and the self-contained Mobile Powers Source 17 make the Visual Remote Monitoring Device 12 independent to be mobile. Mobility is a significant improvement to the Visual Remote Monitoring System, shown in FIG. 2. Mobility for Monitoring Sites 11 includes, but is not limited to Automobiles, Trucks, Trains, Boats, and Pedestrians. This Wireless Wide Area Network (WAN) that the Visual Remote Monitoring Device 12 connects through the Antenna 20 can be, but is not limited to a Cellular Telephone Network.

Turning back to FIG. 2, once the video signal has left the Monitored Site 50 to the Internet 26 using a high-speed connection 57. The video signal is captured and stored by the Service Provider's Storage 59 through connection 58 for later review by the authorized person remotely monitoring the Monitored Site 50. The person who would want access to this stored video on the Service Provider Storage Device 59 can be either mobile using a Wireless Mobile Device 34 or at a fixed location with a Personal Computer 28. A person at the Personal Computer 28 would request access to the stored video by way of the Internet 26 through a high-speed connection 27 and then from the Internet 26 connected to the Service Provider Storage 59 by way of another high-speed connection 60. If the person is mobile their Wireless Mobile Device 34 can access the stored Video on the Service Provider Storage device 59 by wirelessly connecting through an Radio Frequency (RF) 33 connection to the Wireless Wide Area Network (WAN) Base Station 32 that is connected to a Wireless WAN Central Office 30 by way of transmission cables 31. In turn, the Wireless WAN Central Office 30 connects to the Internet 26 through a high-speed connection 61, which follows a similar path to the Service Provider Storage 59 as the Personal Computer 28 through a connection 60. This system approach has a significant privacy issue for the authorized person that wants their Monitored Site 50 monitored, because the video is stored at the Service Provider Storage 59, is not in control of the authorized person. Because the Service Provider of this type of remote monitoring service stores all customer video on this common Service Provider Storage 59, all customers, anyone connected to the Internet 26 with a computer, and any person at the facility of the Service Provider Storage 59 can all potentially gain access to any customer's stored video on the Service Provider Storage 59. Being that there are millions of computers connected to the Internet 26, it is reasonable that a person can obtain unauthorized access to the video stored on the Service Provider Storage 59, commonly known as hacking, through computer skills, and illegal tactics. The Service provider's employees located at the facility of the Service Provider Storage 59 can gain access quite easily. In some actual cases, companies that provide this Remote Monitoring Service advise their customers they will review the video stored on the Service Provider Storage 59. This lack of privacy restricts the authorized person to locate their Camera 51 to monitor locations that they feel are not sensitive to an unauthorized viewer. This issue significantly restricts the authorized person from monitoring whatever they would like.

The invention illustrated in FIG. 1 provides a significant improvement in providing privacy of their video from the Monitoring Site 11 for the owner of the Visual Remote Monitoring Device 12. Turning back to FIG. 1, the location of the recorded video is different than that of the system in FIG. 2 of a typical Visual Remote Monitoring System. The difference is the video is stored in the Data Storage/Memory mechanism 14 of FIG. 1. This video can be viewed remotely by an authorized person using a Wireless Mobile Device 34. The authorized person can contact the Visual Remote Monitoring Device 12 by sending a request radio frequency (RF) signal 33 to a nearby Wireless WAN Base Station 32 which sends the request using transition lines 31 to the Wireless WAN Central Office 30. That Wireless WAN Central Office 30 through transmission lines 29 connects to another Wireless WAN Central Office 24 receiving the request signal. This Wireless WAN Central Office 24 sends the request signal through transmission lines 23 to a Wireless WAN Base Station 22 that is nearest to the Monitored Site 11. The request signal is sent as another RF signal 21 to the Visual Remote Monitoring Device's 12 antenna 20. If the request is properly validated that it is from an authorized person, the video stored in the Data Storage/Memory mechanism 14 in the Visual Remote Monitoring Device 12 is transmitted back to the Wireless Mobile Device 34 in the reverse direction using the same signal path. Additionally, an authorized person can use a Personal Computer 28 to view and store the Video at a fixed location. Similarly to the Wireless Mobile Device 34 a request is sent from the Personal Computer 28 to the Internet 26 through an Internet Connection 27. The Internet 26 transfers the request to the Wireless WAN Central Office 24 through a transmission path 25. This Wireless WAN Central Office 24 sends the request signal through transmission lines 23 to a Wireless WAN Base Station 22 that is nearest to the Monitored Site 11. The request signal is sent as another RF signal 21 to the Visual Remote Monitoring Device's 12 antenna 20. If the request is properly validated that the request is from an authorized person, the video stored in the Data Storage/Memory mechanism 14 in the Visual Remote Monitoring Device 12 is transmitted back to the Personal Computer 28 in the reverse direction using the same signal path. The Visual Remote Monitoring Device 12 will also transfer an exact copy of the video stored in the Data Storage/Memory mechanism 14 within the Visual Remote Monitoring Device 12 to the Personal Computer 28 for further analysis of the video and to free up memory space in the Data Storage/Memory mechanism 14 for more current video to be recorded as the video transferred to the Personal Computer 28 can now be erased at the Data Storage/Memory mechanism 14. In this invention's system there is no third party storing the video data, so there is no possibility of a privacy violation. This allows the owner of the Visual Remote Monitoring Device 12 to have the freedom to view any location at the Monitored Site 11.

In addition to privacy, the invention is secure from unauthorized access or intrusion of the video directly at the Monitored Site (50 of FIG. 2 and 11 of FIG. 1). The system in this invention illustrated in FIG. 1 has higher security than that found in the system shown in FIG. 2. Turning back to FIG. 2, the equipment at the Monitored Site 50, communicates using the Internet 26. Being that there are millions of computers connected to the Internet 26, it is reasonable that a person can obtain unauthorized access, commonly known as hacking, to the Monitored Site's monitoring system in FIG. 2 through computer skills, and illegal tactics. Whereas, this invention is not connected directly to the Internet 26 but wirelessly connects to the outside world. Being wireless adds additional security. If an unauthorized person were to try to directly connect and interrogate the Visual Remote Monitoring Device 12, they would need additional information then if the Visual Remote Monitoring Device 12 were connected to the Internet 26 directly. This person would need to know the RF frequency of operation, the wireless access protocol, and be in the area of the Monitored Site 11. This substantially reduces the chances of unauthorized access of the Visual Remote Monitoring Device 12 and its video stored in the Data Storage/Memory mechanism 14.

Another feature of the invention is to automatically send video and data from the Monitored Site 11 of FIG. 1 to a authorized person at a remote location when something occurs at the Monitored Site 11. This feature frees the authorized person from having to constantly view the activities at the Monitored Site 11 in FIG. 1. Turning to FIG. 1, Environmental Sensors 19 are connected to the Visual Remote Monitoring Device 12 that detect changes at the Monitored Site 11. Specific level of changes at the Monitored Site 11 detected by the Environmental Sensors 19 are set to trigger alerts to a remote authorized person. For example but not limited to these, Environmental Sensors 19 can detect movement, light, shock, windspeed, location, temperature changes, smoke, and noises that can all be of importance to a person that is remote from the Monitored Site 11. Events such as a fire, a break in, severe weather, or simply the authorized person's children arrival at home, are among some examples of events at Monitored Site 11 that would be of interest to the authorized person. These alerts send the video and data at the time of the alert automatically to the authorized person's remote Personal Computer 28 of FIG. 1 and their Wirless Mobile Device 34 of FIG. 1. This path is the same as previous discussed of Video being transmitted to Personal Computer 28 and the Wirless Mobile Device 34 of FIG. 1. When these alerts are received by the authorized person at their remote location, they can review the video and Environmental Sensor 19 data and determine the course of action.

Another patentably important feature of the invention is its improved reliability over the system at the Monitored Site 50 of FIG. 2. Turning to FIG. 2, the system within the Monitored Site 50, consisting of a Camera 51, a Central Processing Unit 53 and an Internet Modem 55 are all powered by AC Power 56 from the local power utility. Additionally, the communications to the authorized person at a remote location is through the Internet 26 accomplished by a Wire 57 leaving the Monitored Site 50. It is a well known by unauthorized intruders such as a burglar, that if the AC power, the phone lines, and the cable TV were all cut entering the Monitored Site 50, the unauthorized intruder will have a higher success of avoiding getting caught or observed by a Surveillance system because the system will cease operation and has no ability to communicate with anyone because phone lines and cable TV wires were cut. Turning to FIG. 1, the Visual Remote Monitoring Device 12 is self powered with Mobile Power 17 and its connection outside of the Monitored Site 11 is wireless 21, so an unauthorized intruder of the Monitored Site 11 will not be able to cause the Visual Remote Monitoring Device 12 to fail by cutting AC power, phone lines, and cable TV.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for visual and environmental monitoring that is able to be installed at a location that is mobile comprising: a radio transceiver; an antenna; a visual input device; a mobile power source.

2. The apparatus for visual and environmental monitoring a mobile location remotely as claimed in claim 1 wherein said radio transceiver wirelessly connects to a Wireless Wide Area Network

3. The apparatus for visual and environmental monitoring a mobile location remotely as claimed in claim 2 wherein said radio transceiver wirelessly connects to a Cellular Telephone Network

4. The apparatus for visual and environmental monitoring a mobile location remotely as claimed in claim 1 wherein said visual input device is a digital image sensor

5. The apparatus for visual and environmental monitoring a mobile location remotely as claimed in claim 4 wherein said visual input device is a digital video camera

6. The apparatus for visual and environmental monitoring a mobile location remotely as claimed in claim 1 wherein said mobile power source is a battery

7. The apparatus for visual and environmental monitoring a mobile location remotely as claimed in claim 6 wherein said mobile power source is a rechargeable battery

8. An apparatus for visual and environmental monitoring a location remotely with privacy and secure from unauthorized access of the recorded video and data comprising: a radio transceiver; an antenna; a visual input device; a central processing unit; a data storage mechanism.

9. The apparatus for visual and environmental monitoring a location remotely as claimed in claim 8 wherein said central processing unit is a microcomputer

10. The apparatus for visual and environmental monitoring a location remotely as claimed in claim 8 wherein said central processing unit is a microprocessor

11. The apparatus for visual and environmental monitoring a location remotely as claimed in claim 8 wherein said data storage mechanism is a solid-state integrated circuit consisting of digital memory cells

12. The apparatus for visual and environmental monitoring a location remotely as claimed in claim 8 wherein said data storage mechanism is a device that magnetically stores data

13. An apparatus for visual and environmental monitoring a location remotely with high reliability comprising: a radio transceiver; an antenna; a visual input device; a central processing unit; a data storage mechanism; a mobile power source.
